(19) United States
(12) Patent Application Publication
(10) Pub. No.: US 2007/0231034 A1
(43) Pub. Date: Oct. 4, 2007

(54) IMAGE FORMING APPARATUS AND SHEET FEED CONTROL METHOD

(75) Inventor: Kazumasa Yasui, Tokyo (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/694,561

(22) Filed: Mar. 30, 2007

(30) Foreign Application Priority Data
Mar. 31, 2006 (JP) 2006-096965

(51) Int. Cl. G03G 15/00

(52) U.S. Cl. 399/401

(57) ABSTRACT

To provide a technique capable of contributing a reduction of user's uncomfortable feeling caused by noise while maintaining double-sided productivity in an intra discharge type image forming apparatus that uses an ADU to perform image forming processing for both sides of a sheet.

An intra discharge type image forming apparatus that uses an ADU to form an image onto both sides of a sheet and discharges the sheet on which an image has been formed to the vicinity of the center of the apparatus comprises: a sheet type information acquisition section 101 that acquires information concerning a bending rigidity of a sheet to be subjected to double-sided printing in the image forming apparatus as sheet type information; and a feed controller 102 that controls a sheet feed speed in a switchback feed section for sheet switchback feed and ADU based on the sheet type information acquired by the sheet type information acquisition section such that the higher the bending rigidity of a sheet, the lower the sheet feed speed.

### BACKGROUND OF THE INVENTION

1. Field of the Invention

The present invention relates to a sheet feed control in an image forming apparatus and, more particularly, to a sheet feed control to be performed in an intra discharge type image forming apparatus that uses an ADU (Auto Duplex Unit) capable of automatically changing the printing side of a sheet serving as a recording medium to form an image onto both sides of the sheet and discharges the sheet on which an image has been formed to the vicinity of the center of the apparatus.

2. Description of the Related Art

There is known an intra discharge type image forming apparatus that uses an ADU to form an image onto both sides of a sheet and discharges the sheet on which an image has been formed to the vicinity of the center of the apparatus. A switchback feed structure in the intra discharge type image forming apparatus is simple in terms of both control and structure, so that it is possible to offer an apparatus moderate in price.

In general, in an image forming apparatus of an intra discharge type that uses a discharge roller to feed a sheet in a switchback manner, it is difficult to increase the proportion of the image processing speed at the time of double-sided printing (double-sided productivity) relative to the image processing speed (corresponding to so-called PPM (Pages per Minute) or CPM (Copies per Minute)) at the time of single-sided printing.

When the process speed is increased in order to improve the double-sided productivity, intervals between sheets sequentially fed at the time of image forming are increased, causing a disadvantage that the maintenance cycle of a photoreceptor which is expendable supplies becomes shorter.

Further, slits for heat release of a sheet feed unit such as an ADU is often directed outward of the apparatus body in the intra discharge type image forming apparatus, so that noise generated in the ADU at the time of sheet feed is directly leaked outside the apparatus through the slits. In particular, when a sheet is fed at a high speed in a switchback manner to the ADU, if the sheet is firm (having bending rigidity) like a thick paper, the edge portion of the sheet is jumped at the joint portion of a sheet guide to hit the guide surface, causing a hitting sound. Further, in the case of a sheet having a long length in the sheet feed direction (long sheet such as A3 sheet), it requires comparatively long time for sheet feeding in the switchback and ADU mechanisms, which may increase noise (rubbing sound of a feed roller or sheet, drive sound of a drive train) resulting from the operation of a drive system. When such noise resulting from an increase in the sheet feed speed is leaked outside through the slits, a user may feel uncomfortable.

When the process speed is made excessively low, intervals between sheets sequentially fed at the time of image forming are reduced, causing a longer waiting time from when a sheet switched back by an exit roller and completely fed to the ADU side until a subsequent sheet is received by the exit roller, unfavorably degrading the double-sided productivity. FIG. 6 is a view showing a state where a subsequent sheet is waiting for at a predetermined position until a preceding sheet has completely been fed to the ADU entrance side by the exit roller (until a subsequent sheet can be fed to the exit roller side). FIG. 7 is a view for explaining a sheet jam resulting from collision between the preceding and subsequent sheets occurring when a sufficient waiting time is not set for the subsequent sheet.

As described above, in the case where double-sided printing is performed in the intra discharge type image forming apparatus, achievement of a good balance between noise reduction and maintaining of double-sided productivity has been required.

### SUMMARY OF THE INVENTION

An object of the embodiment of the invention is to provide a technique capable of contributing a reduction of user's uncomfortable feeling caused by noise while maintaining double-sided productivity in an intra discharge type image forming apparatus that uses an ADU to perform image forming processing for both sides of a sheet.

To solve the above problems, according to a first aspect of the present invention, there is provided an intra discharge type image forming apparatus that uses an ADU to form an image onto both sides of a sheet and discharges the sheet on which an image has been formed to the vicinity of the center of the apparatus, comprising: a sheet type information acquisition section that acquires information concerning a bending rigidity of a sheet to be subjected to double-sided printing in the image forming apparatus as sheet type information; and a feed controller that controls a sheet feed speed in a switchback feed section for sheet switchback feed and ADU based on the sheet type information acquired by the sheet type information acquisition section such that the higher the bending rigidity of a sheet, the lower the sheet feed speed.

According to a second aspect of the present invention, there is provided an intra discharge type image forming apparatus that uses an ADU to form an image onto both sides of a sheet and discharges the sheet on which an image has been formed to the vicinity of the center of the apparatus, comprising: a sheet type information acquisition section that acquires information concerning a feed-direction length of a sheet to be subjected to double-sided printing in the image forming apparatus as sheet type information; and a feed controller that controls a sheet feed speed in a switchback feed section for sheet switchback feed and ADU based on the sheet type information acquired by the sheet type information acquisition section such that the longer the feed-direction size of a sheet, the lower the sheet feed speed.

According to a third aspect of the present invention, there is provided a sheet feed control method in an intra discharge type image forming apparatus that uses an ADU to form an image onto both sides of a sheet and discharges the sheet on which an image has been formed to the vicinity of the center of the apparatus, comprising: acquiring, as sheet type information, information concerning the bending rigidity of a sheet to be subjected to double-sided printing in the image forming apparatus; and controlling a sheet feed speed in a switchback feed section for sheet switchback feed and ADU based on the sheet type information acquired by the sheet type information acquisition step such that the higher the bending rigidity of a sheet, the lower the sheet feed speed.

According to a fourth aspect of the present invention, there is provided a sheet feed control method in an intra discharge type image forming apparatus that uses an ADU to form an image onto both sides of a sheet and discharges the sheet on which an image has been formed to the vicinity of the center of the apparatus, comprising: acquiring, as sheet type information, information concerning a feed-direction length of a sheet to be subjected to double-sided printing in the image forming apparatus; and controlling a sheet feed speed in a switchback feed section for sheet switchback feed and ADU based on the sheet type information acquired by the sheet type information acquisition step such that the longer the feed-direction size of a sheet, the lower the sheet feed speed.

### BRIEF DESCRIPTION OF THE DRAWINGS

FIG. 1 is a view showing the entire configuration of an image forming apparatus M according to an embodiment of the present invention;

FIG. 2 is a functional block diagram for explaining the image forming apparatus M according to the present embodiment;

FIG. 3 is a table showing setting values of the sheet feed speed in a switchback feed section 904 and ADU 905 controlled by a feed controller 102;

FIG. 4 is a speed diagram showing a variation in the sheet feed speed of an exit roller when a sheet that has been subjected to image forming processing is fed in a switchback manner;

FIG. 5 is a flowchart for explaining the flow of processing (sheet feed control method) performed in the image forming apparatus according to the present embodiment;

FIG. 6 is a view showing a state where a subsequent sheet is waiting for at a predetermined position until a preceding sheet has completely been fed to the ADU entrance side by the exit roller; and

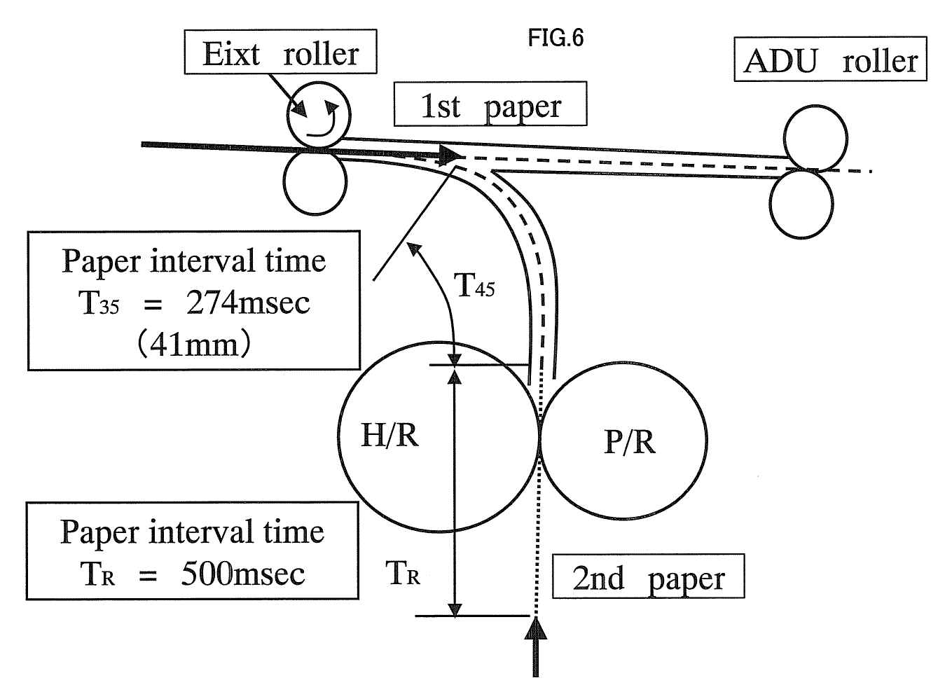

FIG. 7 is a view for explaining a sheet jam resulting from collision between preceding and subsequent sheets occurring when a sufficient waiting time is not set for the subsequent sheet.

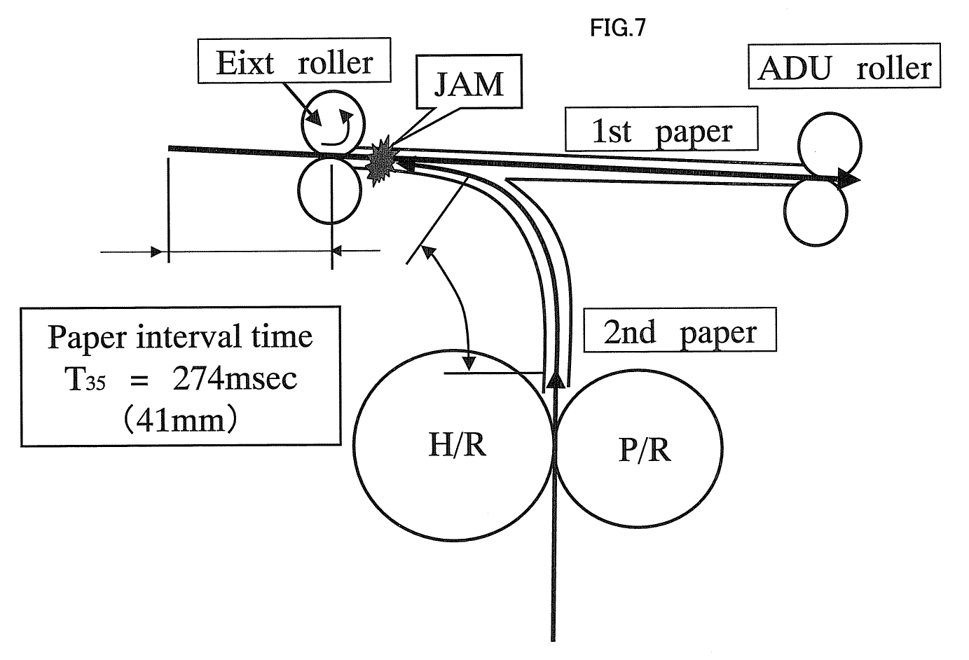

### DETAILED DESCRIPTION OF THE PREFERRED EMBODIMENT

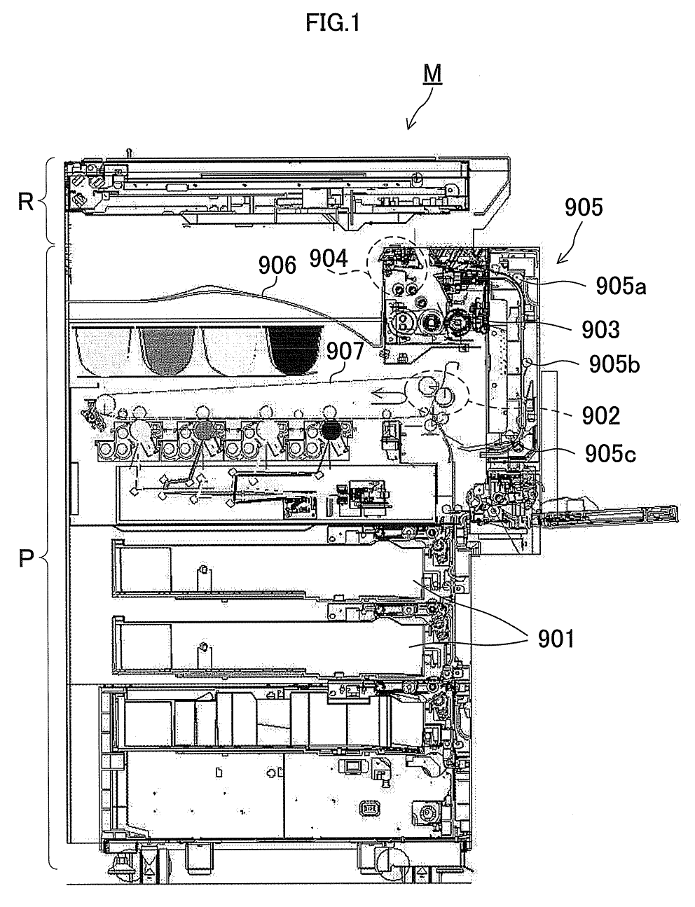

An embodiment of the present invention will be described below with reference to the accompanying drawings. FIG. 1 is a view showing the entire configuration of an image forming apparatus M according to an embodiment of the present invention. As shown in FIG. 1, the image forming apparatus M according to the present embodiment includes an image reading section R for reading an image of a document and an image forming section P for forming an image on a sheet.

The image forming section P includes a sheet supply cassette 901, a transfer section 902, a fixing section 903, a switchback feed section 904, an ADU (Auto Duplex Unit) 905, and a discharge tray 906. In the following, the outline of the flow of double-sided printing operation for a sheet performed in the image forming apparatus M according to the present embodiment will be described.

A sheet fed (supplied) to a sheet feed path from the sheet supply cassette 901 is fed along the sheet feed path toward the transfer section 902. Then, a toner image formed on the belt surface of an intermediate transfer belt 907 is transferred (so-called secondary transfer) onto a first side of the sheet in the transfer section 902 constituted by the belt surface and a transfer roller.

Subsequently, the sheet on the first side of which the toner image has been transferred is fed to the fixing section 903 where the toner image is thermally fixed onto the first side of the sheet. The sheet on the first side of which the toner image has thermally been fixed is fed to the switchback feed section 904 and is then fed in a switchback manner to the ADU 905 by the switchback feed section 904. The switchback feed section 904 and ADU 905 cooperate to reverse the sheet for double-sided printing.

The sheet that has been taken in the ADU 905 is fed through the ADU toward the fixing section 903 once again, where a toner image is formed onto a second surface thereof, and is then fed to the fixing section 903. The sheet on both sides of which the toner images have been formed in this manner is discharged onto a discharge tray 906. As described above, the image forming apparatus M according to the present embodiment serves as an intra discharge type image forming apparatus that uses the ADU 905 to form an image onto both sides of a sheet and discharges the sheet on which an image has been formed to the discharge tray 906 located in the vicinity of the center of the apparatus.

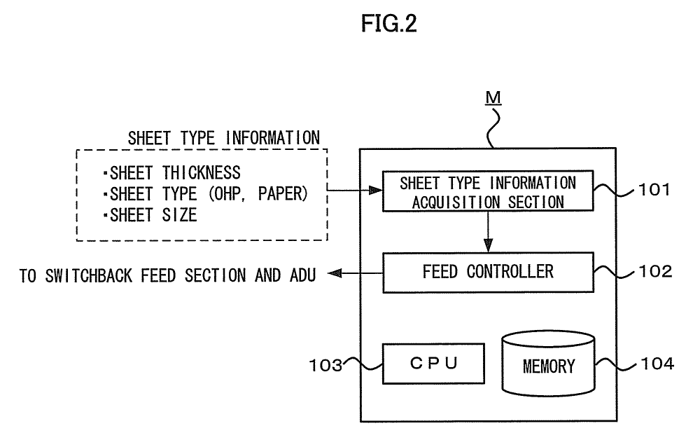

FIG. 2 is a functional block diagram for explaining the image forming apparatus M according to the present embodiment. The image forming apparatus M includes a sheet type information acquisition section 101, a feed controller 102, a CPU 103, and a MEMORY 104.

The sheet type information acquisition section 101 acquires information concerning the bending rigidity of a sheet to be subjected to double-sided printing in the image forming apparatus M as sheet type information. The sheet type information in this embodiment means information (model number of sheet or information indicating gloss level of sheet surface) concerning at least one of the thickness and material of a sheet. The information indicating the gloss level of the sheet surface may be acquired based on a user's input operation on a not shown control panel of the image forming apparatus M or acquired by an optical sensor or the like detecting reflectance of the sheet surface.

Further, the sheet type information acquisition section 101 can acquire information concerning the feed-direction length of a sheet to be subjected to double-sided printing in the image forming apparatus M as sheet type information. As the “information concerning the feed-direction length of a sheet”, information concerning the size of the sheet (sheet size such as A4 size or A3 size, model number of sheet, or feed-direction length of irregular size sheet arbitrarily set by user) is acquired.

Based on the sheet type information acquired by the sheet type information acquisition section 101, the feed controller 102 controls the sheet feed speed in the switchback feed section 904 and ADU 905 such that the higher the bending rigidity of a sheet, the lower the sheet feed speed.

More specifically, the feed controller 102 controls the sheet feed speed such that the following expression is satisfied:

V3≦V1×(VP3/VP1)

where V3 is sheet feed speed in the switchback feed section 904 and ADU 905 set for a sheet having bending rigidity greater than a predetermined value (so-called a thick paper); VP3 is process speed at the time of image forming on the thick paper; V1 is sheet feed speed in the switchback feed section 904 and ADU 905 set for a regular paper; and VP1 is process speed at the time of image forming on the regular paper. In the present embodiment, “regular paper” is assumed to be a regular copier paper having a size equal to or smaller than A4/LT size. Assuming that V1=150 mm/sec, VP1=150 mm/sec, VP3=75 mm/sec, V3 becomes a value not more than 75 mm/sec.

Typically, the process speed at the time of performing image forming processing for a thick paper is set to about ½ of the process speed set for a regular paper, so that even when the sheet feed speed in the switchback feed section and ADU for a thick paper is set to not more than ½ of that for a regular paper, double-sided productivity equivalent or more than in the case where single-side printing is performed can be achieved. This reduces a hitting sound occurring when the edge portion of the sheet hits the guide surface at the joint portion of a sheet guide, thereby eliminating uncomfortable feeling given to a user. Further, it is often the case that the PPM needs to be lowered further and process speed needs to be lowered since a large quantity of heat for fixing is required as the basis weight of a thick paper becomes higher. In such a case, it is considered possible to lower the sheet feed speed further.

Further, based on the sheet type information acquired by the sheet type information acquisition section 101, the feed controller 102 can control the sheet feed speed in the switchback feed section 904 and ADU 905 such that the longer the feed-direction size of a sheet, the lower the sheet feed speed.

In this case, the feed controller 102 controls the sheet feed speed such that the following expression is satisfied:

V3≈V2×(VP3/VP2)

where V2 is sheet feed speed in the switchback feed section 904 and ADU 905 set for a sheet having a feed-direction length larger than a predetermined value; VP2 is process speed at the time of image forming on the long-size paper; V3 is sheet feed speed in the switchback feed section 904 and ADU 905 set for a thick paper; and VP3 is process speed at the time of image forming on the thick paper. Assuming that V2=400 mm/sec, VP3=75 mm/sec, VP2=150 mm/sec, V3 becomes about 200 mm/sec.

Since one-page circulation method in which image forming processing is performed onto one side and then another image forming processing is performed onto the other side is adopted, in the case where image forming processing is performed for a long paper having a feed-direction length larger than that of A4/LT, it takes too long for the long paper to return to the resist roller once again after being reversed. Even if the sheet feed speed after the sheet reversal is increased by 1.5 times, compared to the current value, to 600 mm/sec, double-sided productivity will be improved only by 2 to 3% but, conversely, rubbing sound of a sheet at the feed time or drive sound at the switchback time is increased due to the increase in the sheet feed time. Therefore, the sheet feed speed in the switchback feed section 904 and ADU 905 at the feed time of a long sheet is made lower than that for a regular paper, thereby reducing the sound of the motor running for a long time during the feed time of the long paper to a level of a normal operating sound of the apparatus. This prevents a user from feeling uncomfortable by the motor drive sound.

On the other hand, in the case where image forming processing is performed for a short paper having a feed-direction length equal to or smaller than that of A4/LT, it takes shorter time for the sheet to be reversed and fed. Therefore, the user does not feel uncomfortable by the sound at the time of reversal feed of a sheet or rubbing sound of a sheet, so that the sheet feed speed in the switchback feed section and ADU can be increased to a certain degree.

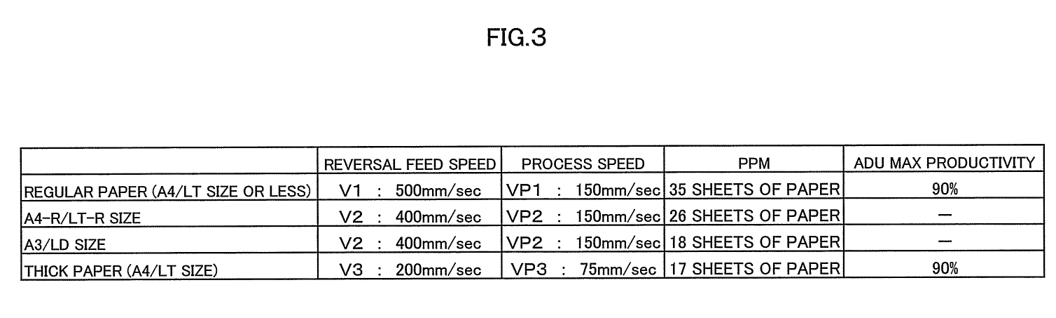

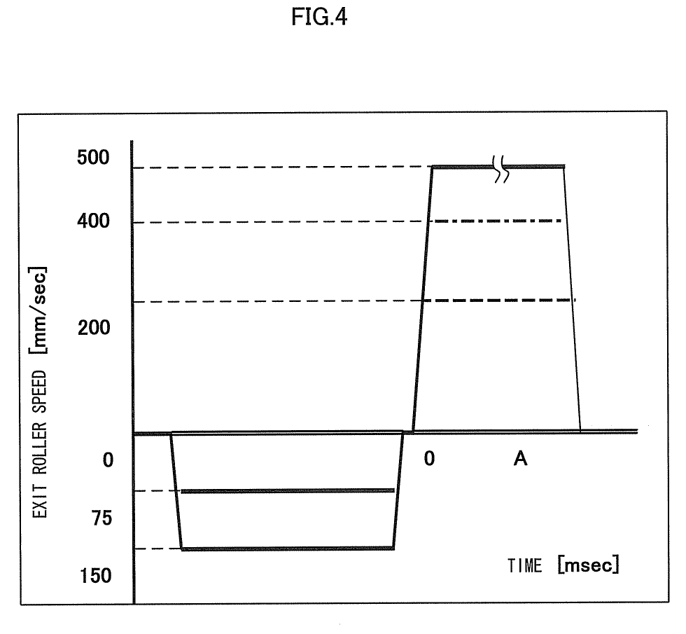

FIG. 3 is a table showing setting values of the sheet feed speed in the switchback feed section 904 and ADU 905 controlled by the feed controller 102, and FIG. 4 is a speed diagram showing a variation in the sheet feed speed of the exit roller when a sheet that has been subjected to image forming processing is fed in a switchback manner. As shown in FIGS. 3 and 4, the image forming apparatus M according to the present embodiment has three sheet feed speeds in the switchback feed section 904 and ADU 905 and has two process speeds. Further, it can be seen that in the case where the above thick paper is fed, double-sided productivity of 90% can be achieved to realize a good balance between noise reduction and maintaining of double-sided productivity.

The CPU 103 has a role of executing various processings in the image forming apparatus and, at the same time, has a role of executing a program stored in the MEMORY 104 so as to realize various functions. The MEMORY 104, which is constituted by an ROM or RAM, has a role of storing various information or programs used in the image forming apparatus.

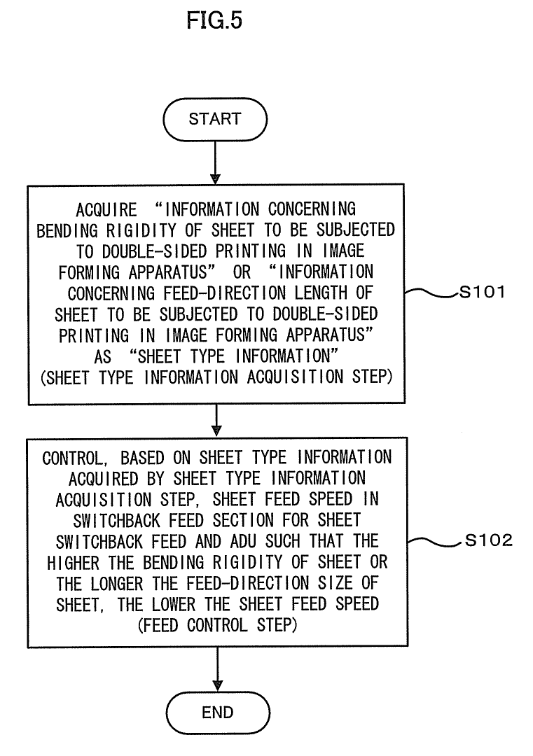

FIG. 5 is a flowchart for explaining the flow of processing (sheet feed control method) performed in the image forming apparatus according to the present embodiment.

The sheet type information acquisition section 101 acquires “information concerning the bending rigidity of a sheet to be subjected to double-sided printing in the image forming apparatus” or “information concerning the feed-direction length of a sheet to be subjected to double-sided printing in the image forming apparatus” as “sheet type information” (sheet type information acquisition step) (S101).

Based on the sheet type information acquired by the sheet type information acquisition step, the feed controller 102 controls the sheet feed speed in the switchback feed section for sheet switchback feed and ADU such that the higher the bending rigidity of a sheet or the longer the feed-direction size of a sheet, the lower the sheet feed speed (feed control step) (S102).

The above respective steps in the processing performed in the image forming apparatus are realized by the CPU 103 executing a sheet feed control program stored in the MEMORY 104.

In the present embodiment, there has been explained the case where the function for implementing the present invention is previously stored inside the apparatus, but the present invention is not limited thereto, and a similar function may be downloaded from the network into the apparatus or a recording medium on which a similar function is stored is installed in the apparatus. The recording medium may be any form of recording medium such as CD-ROM which can store programs and is readable by the apparatus. The function which can be previously obtained through installing or downloading may be realized in cooperation with the OS (operating system) inside the apparatus.

As described above, the sheet feed speed V1 exhibiting a satisfactory effect of improving double-sided productivity is set for a sheet having a size equal to or less than A4/LT size, while the sheet feed speed V2 at which a stable feed operation can be achieved and less noise is generated is set for sheets of other sizes.

That is not to say that only the sheet feed speed V3 set for a thick paper contributes to improvement in double-sided productivity, but a distance (time) between preceding and subsequent sheets is determined by a relationship between the process speed at the printing time and PPM. The double-sided productivity is deteriorated when the distance between the sheets is small, so that a relationship between the PPM for a regular paper and that for a thick paper is set to 1: 1/2 and relationship between the reversal feed speed for a regular paper and that for a thick paper is set to 1:1/2.5. As a result, double-sided productivity of 90% can be achieved. This is because that an increase in the sheet feed time eliminates the need to increase the reversal feed speed.

Although a paper is mainly used as a printing medium in the above embodiment, various sheets having different rigidity or sizes, such as an OHP film or coated sheet can be employed.

According to the above embodiment, there is provided an intra discharge type image forming apparatus that uses an ADU to form an image onto both sides of a sheet and discharges the sheet on which an image has been formed to the vicinity of the center of the apparatus, comprising: a sheet type information acquisition means for acquiring information concerning a bending rigidity of a sheet to be subjected to double-sided printing in the image forming apparatus as sheet type information; and a feed control means for controlling a sheet feed speed in a switchback feed section for sheet switchback feed and ADU based on the sheet type information acquired by the sheet type information acquisition means such that the higher the bending rigidity of a sheet, the lower the sheet feed speed.

In the image forming apparatus having the above configuration, it is preferable that the sheet type information acquisition means acquires information concerning at least one of the thickness and material of a sheet as the information concerning the bending rigidity of a sheet. Further, in the image forming apparatus having the above configuration, the sheet type information acquisition means can acquire information concerning at least one of a model number of a sheet and information indicating a gloss level of a sheet surface as the information concerning the bending rigidity of a sheet. Further, in the image forming apparatus having the above configuration, it is preferable that the feed control means controls the sheet feed speed such that the following expression is satisfied: V3≦V1×(VP3 /VP1), where V3 is a sheet feed speed in the switchback feed section and ADU set for a sheet having bending rigidity greater than a predetermined value; VP3 is a process speed at the time of image forming on the sheet; V1 is a sheet feed speed in the switchback feed section and ADU set for a regular paper having a size equal to or less than A4/LT size; and VP1 is a process speed at the time of image forming on the regular paper having a size equal to or less than A4/LT size.

Further, according to the above embodiment, there is provided an intra discharge type image forming apparatus that uses an ADU to form an image onto both sides of a sheet and discharges the sheet on which an image has been formed to the vicinity of the center of the apparatus, comprising: a sheet type information acquisition means for acquiring information concerning a feed-direction length of a sheet to be subjected to double-sided printing in the image forming apparatus as sheet type information; and a feed control means for controlling a sheet feed speed in a switchback feed section for sheet switchback feed and ADU based on the sheet type information acquired by the sheet type information acquisition means such that the longer the feed-direction size of a sheet, the lower the sheet feed speed.

In the image forming apparatus having the above configuration, it is preferable that the sheet type information acquisition means acquires information concerning the size of a sheet as the information concerning the feed-direction length of a sheet. Further, in the image forming apparatus having the above configuration, the sheet type information acquisition means can acquire information indicating any of the size of a sheet, model number of a sheet, and feed-direction length of an irregular size sheet arbitrarily set by a user as the information concerning the feed-direction length of a sheet. Further, in the image forming apparatus having the above configuration, it is preferable that the feed control means controls the sheet feed speed such that the following expression is satisfied: V3≈V2×(VP3/VP2), where V2 is a sheet feed speed in the switchback feed section and ADU set for a sheet having a feed-direction length larger than a predetermined value; VP2 is a process speed at the time of image forming on the sheet; V3 is a sheet feed speed in the switchback feed section and ADU set for a thick paper; and VP3 is a process speed at the time of image forming on a thick paper.

Although the exemplary embodiment of the present invention has been shown and described, it will be apparent to those having ordinary skill in the art that a number of changes, modifications, or alternations to the invention as described herein may be made within the spirit of the present invention.

As has been described in detail, according to the present invention, it is possible to provide a technique capable of contributing a reduction of user's uncomfortable feeling caused by noise while maintaining double-sided productivity in an intra discharge type image forming apparatus that uses an ADU to perform image forming processing for both sides of a sheet.

What is claimed is:

1. An intra discharge type image forming apparatus that uses an ADU to form an image onto both sides of a sheet and discharges the sheet on which an image has been formed to the vicinity of the center of the apparatus, comprising:
a sheet type information acquisition section that acquires information concerning a bending rigidity of a sheet to be subjected to double-sided printing in the image forming apparatus as sheet type information; and
a feed controller that controls a sheet feed speed in a switchback feed section for sheet switchback feed and ADU based on the sheet type information acquired by the sheet type information acquisition section such that the higher the bending rigidity of a sheet, the lower the sheet feed speed.

2. The image forming apparatus according to claim 1, wherein
the sheet type information acquisition section acquires information concerning at least one of the thickness and material of a sheet as the information concerning the bending rigidity of a sheet.

3. The image forming apparatus according to claim 1, wherein
the sheet type information acquisition section acquires information concerning at least one of a model number of a sheet and information indicating a gloss level of a sheet surface as the information concerning the bending rigidity of a sheet.

4. The image forming apparatus according to claim 2, wherein
the feed controller controls the sheet feed speed such that the following expression is satisfied:
V3≦V1×(VP3/VP1)
where V3 is a sheet feed speed in the switchback feed section and ADU set for a sheet having bending rigidity greater than a predetermined value; VP3 is a process speed at the time of image forming on the sheet; V1 is a sheet feed speed in the switchback feed section and ADU set for a regular paper having a size equal to or less than A4/LT size; and VP1 is a process speed at the time of image forming on the regular paper having a size equal to or less than A4/LT size.

5. An intra discharge type image forming apparatus that uses an ADU to form an image onto both sides of a sheet and discharges the sheet on which an image has been formed to the vicinity of the center of the apparatus, comprising:
a sheet type information acquisition section that acquires information concerning a feed-direction length of a sheet to be subjected to double-sided printing in the image forming apparatus as sheet type information; and
a feed controller that controls a sheet feed speed in a switchback feed section for sheet switchback feed and ADU based on the sheet type information acquired by the sheet type information acquisition section such that the longer the feed-direction size of a sheet, the lower the sheet feed speed.

6. The image forming apparatus according to claim 5, wherein
the sheet type information acquisition section acquires information concerning the size of a sheet as the information concerning the feed-direction length of a sheet.

7. The image forming apparatus according to claim 5, wherein
the sheet type information acquisition section acquires information indicating any of the size of a sheet, model number of a sheet, and feed-direction length of an irregular size sheet arbitrarily set by a user as the information concerning the feed-direction length of a sheet.

8. The image forming apparatus according to claim 6, wherein
the feed controller controls the sheet feed speed such that the following expression is satisfied:
V3≈V2×(VP3/VP2)
where V2 is a sheet feed speed in the switchback feed section and ADU set for a sheet having a feed-direction length larger than a predetermined value; VP2 is a process speed at the time of image forming on the sheet;
V3 is a sheet feed speed in the switchback feed section and ADU set for a thick paper; and VP3 is a process speed at the time of image forming on the thick paper.

9. A sheet feed control method in an intra discharge type image forming apparatus that uses an ADU to form an image onto both sides of a sheet and discharges the sheet on which an image has been formed to the vicinity of the center of the apparatus, comprising:
acquiring, as sheet type information, information concerning a bending rigidity of a sheet to be subjected to double-sided printing in the image forming apparatus; and
controlling a sheet feed speed in a switchback feed section for sheet switchback feed and ADU based on the sheet type information acquired by the sheet type information acquisition step such that the higher the bending rigidity of a sheet, the lower the sheet feed speed.

10. The sheet feed control method according to claim 9, wherein
the sheet type information acquisition step acquires information concerning at least one of the thickness and material of a sheet as the information concerning the bending rigidity of a sheet.

11. The sheet feed control method according to claim 9, wherein
the sheet type information acquisition step acquires information concerning at least one of a model number of a sheet and information indicating a gloss level of a sheet surface as the information concerning the bending rigidity of a sheet.

12. The sheet feed control method according to claim 10, wherein
the feed control step controls the sheet feed speed such that the following expression is satisfied:
V3≦V1×(VP3/VP1)
where V3 is a sheet feed speed in the switchback feed section and ADU set for a sheet having bending rigidity greater than a predetermined value; VP3 is a process speed at the time of image forming on the sheet; V1 is a sheet feed speed in the switchback feed section and ADU set for a regular paper having a size equal to or less than A4/LT size; and VP1 is a process speed at the time of image forming on the regular paper having a size equal to or less than A4/LT size.

13. A sheet feed control method in an intra discharge type image forming apparatus that uses an ADU to form an image onto both sides of a sheet and discharges the sheet on which an image has been formed to the vicinity of the center of the apparatus, comprising:
acquiring, as sheet type information, information concerning a feed-direction length of a sheet to be subjected to double-sided printing in the image forming apparatus; and
controlling a sheet feed speed in a switchback feed section for sheet switchback feed and ADU based on the sheet type information acquired by the sheet type information acquisition step such that the longer the feed-direction size of a sheet, the lower the sheet feed speed.

14. The sheet feed control method according to claim 13, wherein
the sheet type information acquisition step acquires information concerning the size of a sheet as the information concerning the feed-direction length of a sheet.

15. The sheet feed control method according to claim 13, wherein
the sheet type information acquisition step acquires information indicating any of the size of a sheet, model number of a sheet, and feed-direction length of an irregular size sheet arbitrarily set by a user as the information concerning the feed-direction length of a sheet.

16. The sheet feed control method according to claim 14, wherein
the feed control step controls the sheet feed speed such that the following expression is satisfied:
V3≈V2×(VP3/VP2)
where V2 is a sheet feed speed in the switchback feed section and ADU set for a sheet having a feed-direction length larger than a predetermined value; VP2 is a process speed at the time of image forming on the sheet; V3 is a sheet feed speed in the switchback feed section and ADU set for a thick paper; and VP3 is a process speed at the time of image forming on the thick paper.
